(19) United States
(12) Patent Application Publication
(10) Pub. No.: US 2025/0245972 A1
(43) Pub. Date: Jul. 31, 2025

(54) IMAGE DATA PROCESSING METHOD, DEVICE, COMPUTER EQUIPMENT AND STORAGE MEDIUM

(71) Applicant: BEIJING LIUYUAN SPACE INFORMATION TECHNOLOGY CO., LTD., Beijing (CN)

(72) Inventors: Yu Huang, Beijing (CN); Guofeng Sun, Beijing (CN); Yandong Yan, Beijing (CN); Jiayu Zhang, Beijing (CN); Yiwei Lou, Beijing (CN)

(73) Assignee: BEIJING LIUYUAN SPACE INFORMATION TECHNOLOGY CO., LTD., Beijing (CN)

(21) Appl. No.: 18/895,538

(22) Filed: Sep. 25, 2024

(30) Foreign Application Priority Data
Jan. 30, 2024 (CN) 202410125078.X

(51) Int. Cl. G06V 10/774; G06V 10/54; G06V 10/764; G06V 10/776; G06V 10/80

(52) U.S. Cl. CPC G06V 10/774; G06V 10/54; G06V 10/764; G06V 10/776; G06V 10/806; G06V 2201/03

(57) ABSTRACT

The present application discloses an image data processing method, a device, a computer equipment, and a storage medium. The method includes: obtaining an image training set, and extracting an image structure feature and an image texture feature in the image training set based on an encoder; reconstructing the image structure feature and the image texture feature to obtain a reconstruction image feature, and decoding, by a shared decoder, the reconstruction image feature to obtain a reconstruction loss value set; classifying, by a classifier, the image structure feature to obtain a classification loss value set, and updating parameters of the encoder and the shared decoder based on the reconstruction loss value set and the classification loss value set; and determining the shared encoder in the encoder as a feature extraction model in response to that an updated encoder meets a training stop condition.

### CROSS-REFERENCE TO RELATED APPLICATIONS

This application claims priority to Chinese Patent Application No. 202410125078.X, all filed on Jan. 30, 2024, the entire contents of which are incorporated herein by reference.

### TECHNICAL FIELD

The present application relates to the technical field of medicine, and in particular to an image data processing method, a device, a computer equipment, and a storage medium.

### BACKGROUND

In the daily hospital diagnosis process, it is necessary to extract features from the image of the diseased region through a feature extraction model to obtain an image feature. Then, the medical image features are recognized and processed according to the image recognition model to determine the diseased type. However, before the feature extraction model is applied, the feature extraction model needs to be trained first.

The current image data processing method is to obtain an image training set from a certain hospital and train a neural network based on the image training set. When the trained neural network meets the training stop condition, the neural network is determined as a feature extraction model.

However, since the processing method of the acquisition equipment is different from the processing method used in constructing image samples, large visual deviations and distribution deviations will occur in the image samples of the image training set, which in turn causes a low extracting accuracy of the feature extraction model when the feature extraction model extracts image features of different images.

### SUMMARY

In view of this, it is necessary to provide an image data processing method, a device, a computer equipment, and a storage medium.

In a first aspect, the present application provides an image data processing method, including:
obtaining an image training set, and extracting an image structure feature and an image texture feature in the image training set based on an encoder;
reconstructing the image structure feature and the image texture feature to obtain a reconstruction image feature, and decoding, by a shared decoder, the reconstruction image feature to obtain a reconstruction loss value set;
classifying, by a classifier, the image structure feature to obtain a classification loss value set, and updating parameters of the encoder and the shared decoder based on the reconstruction loss value set and the classification loss value set; and
determining the shared encoder in the encoder as a feature extraction model in response to that an updated encoder meets a training stop condition, where the feature extraction model is configured to extract an image structure feature in an image.

In an embodiment, the encoder includes the shared encoder and a domain-specific encoder;
the extracting the image structure feature and the image texture feature in the image training set based on the encoder includes:
encoding a first image training set in the image training set based on the shared encoder to obtain a source image structure feature in the image structure feature;
encoding a second image training set in the image training set based on the shared encoder to obtain a target image structure feature in the image structure feature; and
encoding the image training set according to the domain-specific encoder to obtain the image texture feature.

In an embodiment, the domain-specific encoder includes a source domain-specific encoder and a target domain-specific encoder, and the image texture feature includes a source image texture feature and a target image texture feature;
the encoding the image training set according to the domain-specific encoder to obtain the image texture feature includes:
encoding the first image training set according to the source domain-specific encoder to obtain the source image texture feature; and
encoding the second image training set according to the target domain-specific encoder to obtain the target image texture feature.

In an embodiment, the reconstruction image feature includes a source image feature, a target image feature and a mixed image feature, the image structure feature includes a source image structure feature and a target image structure feature, and the image texture feature includes a source image texture feature and a target image texture feature;
the reconstructing the image structure feature and the image texture feature to obtain the reconstruction image feature includes:
splicing the source image structure feature and the source image texture feature to obtain the source image feature;
splicing the target image structure feature and the target image texture feature to obtain the target image feature;
splicing the source image structure feature and the target image texture feature to obtain a first mixed image feature in the mixed image feature; and
splicing the target image structure feature and the source image texture feature to obtain the second mixed image feature in the mixed image feature.

In an embodiment, the reconstruction loss value includes a source reconstruction loss value, a target reconstruction loss value, a first mixed structure loss value, a first mixed texture loss value, a second mixed structure loss value, and a second mixed texture loss value;
the decoding, by the shared decoder, the reconstruction image feature to obtain the reconstruction loss value set includes:
decoding, by the shared decoder, the source image feature to obtain a source image, and determining a source reconstruction loss value corresponding to the source image;
decoding, by the shared decoder, the target image feature to obtain a target image, and determining a target reconstruction loss value corresponding to a target image;
decoding, by the shared decoder, a first mixed image feature to obtain a first mixed image, and determining a first mixed structure loss value and a first mixed texture loss value corresponding to the first mixed image; and
decoding, by the shared decoder, the second mixed image feature to obtain a second mixed image, and determining a second mixed structure loss value and a second mixed texture loss value corresponding to the second mixed image.

In an embodiment, the classification loss value set includes a label transfer loss value, a source segmentation loss value and a target segmentation loss value, and the classifier includes a first classifier and a second classification;
the classifying, by the classifier, the image structure feature to obtain the classification loss value set includes:
classifying, by the first classifier, the image structure feature to obtain the label transfer loss value, where a gradient of the first classifier is an inversion gradient;
classifying, by the second classifier, the image structure feature, and optimizing a classified image structure feature based on the Hilbert Schmidt independent criterion optimization method to obtain an optimized image structure feature; and
weighting the optimized image structure feature, and determining the source segmentation loss value and the target segmentation loss value based on a weighted image structure feature.

In an embodiment, before the determining the shared encoder in the encoder as the feature extraction model in response to that the updated encoder meets the training stop condition, the method further includes:
obtaining an image verification set, and determining whether the encoder reaches an overfitting equilibrium point based on the image verification set;
determining that the encoder meets a preset training stop condition in response to that the encoder reaches the overfitting equilibrium point; and
determining that the encoder does not meet the training stop condition in response to that the encoder does not reach the overfitting equilibrium point, and performing the obtaining the image training set, and extracting the image structure feature and the image texture feature in the image training set based on the encoder.

In a second aspect, the present application further provides an image data processing device, including:
an obtaining module, configured to obtain an image training set, and extract an image structure feature and an image texture feature in the image training set based on the encoder;
a reconstruction module, configured to reconstruct the image structure feature and the image texture feature to obtain a reconstruction image feature, and decode the reconstruction image feature through a shared decoder to obtain a reconstruction loss value set;
a classification module, configured to classify the image structure feature through a classifier to obtain a classification loss value set, and update parameters of the encoder and the shared decoder based on the reconstruction loss value set and the classification loss value set; and
a determination module, configured to determine the shared encoder in the encoder as a feature extraction model in response to that an updated encoder meets a training stop condition, where the feature extraction model is configured to extract an image structure feature in an image.

In a third aspect, the present application further provides a computer equipment including a memory and a processor. The memory stores a computer program, and when the computer program is executed by the processor, following steps are implemented.

Obtaining an image training set, and extracting an image structure feature and an image texture feature in the image training set based on an encoder;
reconstructing the image structure feature and the image texture feature to obtain a reconstruction image feature, and decoding, by a shared decoder, the reconstruction image feature to obtain a reconstruction loss value set;
classifying, by a classifier, the image structure feature to obtain a classification loss value set, and updating parameters of the encoder and the shared decoder based on the reconstruction loss value set and the classification loss value set; and
determining the shared encoder in the encoder as a feature extraction model in response to that an updated encoder meets a training stop condition, where the feature extraction model is configured to extract an image structure feature in an image.

In a fourth aspect, the present application further provides a computer-readable storage medium storing a computer program thereon. When the computer program is executed by a processor, following steps are implemented.
Obtaining an image training set, and extracting an image structure feature and an image texture feature in the image training set based on an encoder;
reconstructing the image structure feature and the image texture feature to obtain a reconstruction image feature, and decoding, by a shared decoder, the reconstruction image feature to obtain a reconstruction loss value set;
classifying, by a classifier, the image structure feature to obtain a classification loss value set, and updating parameters of the encoder and the shared decoder based on the reconstruction loss value set and the classification loss value set; and
determining the shared encoder in the encoder as a feature extraction model in response to that an updated encoder meets a training stop condition, where the feature extraction model is configured to extract an image structure feature in an image.

In the image data processing method, a device, a computer equipment, and a storage medium, obtaining an image training set, and extracting an image structure feature and an image texture feature in the image training set based on an encoder; reconstructing the image structure feature and the image texture feature to obtain a reconstruction image feature, and decoding, by a shared decoder, the reconstruction image feature to obtain a reconstruction loss value set; classifying, by a classifier, the image structure feature to obtain a classification loss value set, and updating parameters of the encoder and the shared decoder based on the reconstruction loss value set and the classification loss value set; and determining the shared encoder in the encoder as a feature extraction model in response to that an updated encoder meets a training stop condition. The feature extraction model is configured to extract an image structure feature in an image. By extracting the image structure features and image texture features in the image training set, and determining the reconstruction loss value set and the classification loss value set based on the image structure features and image texture features, the encoding effect of the current encoder is clarified. Then, the shared encoder in the encoder is determined according to the reconstruction loss value set and the classification loss value set, and a shared encoder that can accurately extract image structure features is obtained. By extracting the common image structure features in the image, the accuracy of the feature extraction model is improved, thereby improving the accuracy of identifying the type of lesions.

### BRIEF DESCRIPTION OF THE DRAWINGS

To illustrate the technical solutions according to the embodiments of the present application or the related art more clearly, the accompanying drawings for describing the embodiments or the related art are introduced briefly in the following. Apparently, the accompanying drawings in the following description are only some embodiments of the present application. Those skilled in the art can derive other drawings from the accompanying drawings without creative efforts.

FIG. 1 is a schematic flowchart of an image data processing method according to an embodiment.

FIG. 2 is a schematic flowchart of steps for extracting the image structure feature and the image texture feature according to an embodiment.

FIG. 3 is a schematic flowchart of steps for extracting the image texture feature according to an embodiment.

FIG. 4 is a schematic flowchart of steps for determining the reconstruction image feature according to an embodiment.

FIG. 5 is a schematic flowchart of steps for determining the reconstruction loss value set according to an embodiment.

FIG. 6 is a schematic flowchart of steps for determining the classification loss value set according to an embodiment.

FIG. 7 is a schematic structural diagram for a determination of processing image structure feature according to an embodiment.

FIG. 8 is a schematic flowchart of steps for determining whether the encoder meets the training stop condition according to an embodiment.

FIG. 9 is a schematic flowchart of determining the reconstruction loss value set and the classification loss value set according to an embodiment.

FIG. 10 is a structure block diagram of an image data processing device according to an embodiment.

FIG. 11 is an internal structure diagram of a computer equipment according to an embodiment.

### DETAILED DESCRIPTION OF THE EMBODIMENTS

In order to make the purpose, technical solutions and advantages of the present application more clear, the present application will be further described in detail below with reference to the drawings and embodiments. It should be understood that the specific embodiments described here are only used to explain the present application and are not used to limit the present application.

In an embodiment, as shown in FIG. 1, an image data processing method is provided. Embodiments of the present application are used for description by taking the method applied to a computer equipment as an example. The embodiment of the present application does not limit an execution equipment for the image data processing method including the following steps 102 to 108.

Step 102, obtaining an image training set, and extracting an image structure feature and an image texture feature in the image training set based on an encoder.

The coder includes a shared coder and a domain-specific coder. Each image sample set is an image sample set of the same type of disease.

During implementation, the computer equipment is pre-set with an encoder. The computer equipment obtains the image sample sets of each hospital through the data transmission interface of each hospital. Then, the computer equipment randomly determines one image sample set in each image sample set as the first image training set, and determines another image sample set as the second image training set. The computer equipment determines the first image training set and the second image training set as image training sets. In addition, the computer equipment determines other image sample sets (excluding the image training set) in each image sample set as image verification sets. The computer equipment extracts the image structure feature of the image training set through the shared encoder. In addition, the computer equipment extracts the image texture feature of the image training set through a domain-specific encoder.

In an embodiment, a computer equipment obtains a plurality of image sample sets of a single disease. Then, the computer equipment selects any two (Cₙ²) from multiple sample sets as the symmetrically decoupled training data set, that is, the image training set. n is the number of image sample sets. C is the number of combinations. Then, the computer equipment determines the remaining n−2 image sample sets as the image verification sets.

It can be understood that, since the collection equipment and the pre-processing method for the image sample are different in various hospitals, there are large visual deviations and distribution deviations in the image samples of each image sample set.

Step 104, reconstructing the image structure feature and the image texture feature to obtain a reconstruction image feature, and decoding, by a shared decoder, the reconstruction image feature to obtain a reconstruction loss value set.

During implementation, the computer equipment performs reconstruction and splicing processing on the image structure feature and the image texture feature to obtain the reconstruction image feature. Then, the computer equipment codes the reconstruction image feature based on the shared decoder to obtain a reconstruction loss value set.

Step 106, classifying, by a classifier, the image structure feature to obtain a classification loss value set, and updating parameters of the encoder and the shared decoder based on the reconstruction loss value set and the classification loss value set.

The classifier includes a first classifier and a second classifier. The classification loss value set includes a label transfer loss value, a source segmentation loss value and a target segmentation loss value.

During implementation, the computer equipment classifies the image structure feature through a first classifier to obtain a label transfer loss value. In addition, the computer equipment classifies the image structure feature through the second classifier, and optimizes the image structure feature after classifying and processing through a preset feature optimization algorithm, to obtain an optimized image structure feature. Then, the computer equipment determines the source segmentation loss value and the target segmentation loss value based on the optimized image structure features. The computer equipment performs data processing on the reconstruction loss value set and the classification loss value set, and updates parameters of the encoder and the shared decoder.

Step 108, determining the shared encoder in the encoder as a feature extraction model in response to that an updated encoder meets a training stop condition.

The feature extraction model is configured to extract an image structure feature in an image.

During implementation, training stop conditions are preset in the computer equipment. When the updated encoder meets the preset training stop condition, the computer equipment determines the shared encoder in the encoder as the feature extraction model. Then, the computer equipment extracts the image structure feature in the image through a feature extraction model, and determines the type of diseased represented by the image based on the image structure feature.

In an embodiment, the computer equipment inputs the image to be recognized into the feature extraction model, and extracts the image structure feature to be recognized of the image to be recognized through the feature extraction model. Then, the computer equipment inputs the image structure feature to be recognized into a preset image recognition model, and performs recognition processing on the image structure feature to be recognized through the image recognition model to obtain the diseased type of the image to be recognized.

In the above image data processing method, by extracting the image structure feature and the image texture feature in the image training set and determining the reconstruction loss value set and the classification loss value set based on the image structure feature and the image texture feature, the effect of the current encoder is clarified. Then, the target shared encoder in the encoder is determined based on the reconstruction loss value set and the classification loss value set, and a target shared encoder that can accurately extract image structure feature is obtained. By extracting the common image structure feature in the image, the accuracy of the feature extraction model is improved, thereby improving the accuracy of identifying the diseased type.

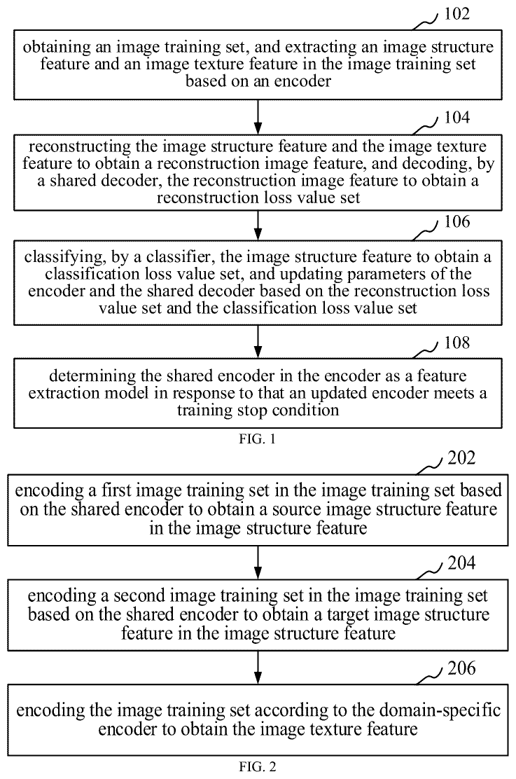

In an embodiment, the encoder includes a shared encoder and a domain-specific encoder. As shown in FIG. 2, the specific process in step 102, extracting the image structure feature and the image texture feature in the image training set based on the encoder includes steps 202 to 206.

Step 202, encoding a first image training set in the image training set based on the shared encoder to obtain a source image structure feature in the image structure feature.

The image training set includes a first image training set and a second image training set. The image structure feature includes the domain invariance. Domain invariance refers to the characteristic that a theory, a rule, a model or a concept that remain unchanged under different conditions in a specific domain. The image structure feature includes a source image structure feature and a target image structure feature.

During implementation, the computer equipment inputs the first image training set into the shared encoder, and performs encoding processing on the first image training set through the shared encoder to obtain the source image structure feature zₛ^{s} in the first image training set.

In an embodiment, the shared encoder and the domain-specific encoder can use visual geometry group network (VGG16). The depth of the shared encoder is deeper than that of the domain-specific encoder, which facilitates the extraction of the image structure feature from the image training set.

Step 204, encoding a second image training set in the image training set based on the shared encoder to obtain a target image structure feature in the image structure feature.

During implementation, the computer equipment inputs the second image training set into the shared encoder, and performs encoding processing on the second image training set through the shared encoder to obtain the target image structure feature zₛ^{t} in the second image training set.

Step 206, encoding the image training set according to the domain-specific encoder to obtain the image texture feature.

The domain-specific encoder includes a source domain-specific encoder and a target domain-specific encoder.

During implementation, the computer equipment encodes the first image training set through the source domain-specific encoder, and encodes the second image training set through the target domain-specific encoder to obtain the image texture feature.

In an embodiment, the computer equipment constructs a shared encoder E^{s} for extracting the image structure feature with domain invariance in an image training set. In addition, the computer equipment constructs a domain-specific encoder {Eₚ^{s}, Eₚ^{t}} that is specific to each data domain (the first image training set and the second image training set) for extracting the image texture feature in the image training set. Eₚ^{s} is the source domain-specific encoder, and Eₚ^{t} is the target domain-specific encoder.

In this embodiment, the image training set is processed through a shared encoder to obtain image structure feature, and the image training set is processed through a domain-specific encoder to obtain the image texture feature, which clarifies that the image training set includes the domain-invariant image structure feature and the domain-specific image texture feature, thereby facilitating subsequent reconstruction processing on the image texture feature and the image structure feature.

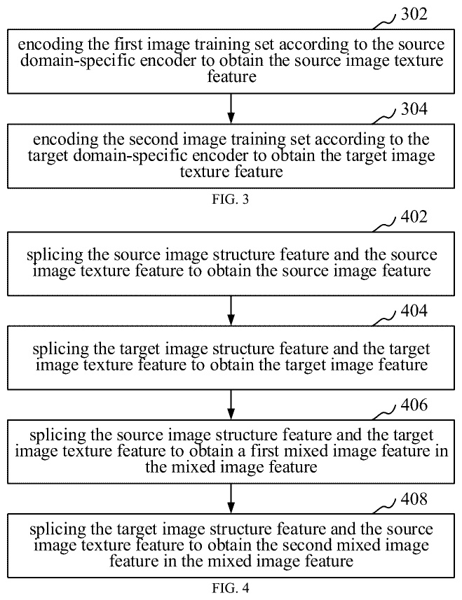

In an embodiment, the domain-specific encoder includes a source domain-specific encoder and a target domain-specific encoder. The image texture feature includes a source image texture feature and a target image texture feature. As shown in FIG. 3, the specific processing process of the step 206 includes steps 302 to 304.

Step 302, encoding the first image training set according to the source domain-specific encoder to obtain the source image texture feature.

During implementation, the computer equipment inputs the first image training set into the source domain-specific encoder, and performs encoding processing on the first image training set through the source domain-specific encoder to obtain the source image texture feature zₚ^{s}.

Step 304, encoding the second image training set according to the target domain-specific encoder to obtain the target image texture feature.

During implementation, the computer equipment inputs the second image training set into the target domain-specific encoder, and performs encoding processing on the second image training set through the target domain-specific encoder to obtain the target image texture feature zₚ^{t}.

In this embodiment, the first image training set is processed through the source domain-specific encoder, and the second image training set is processed through the target domain-specific encoder, thereby obtaining domain-specific image texture feature.

In an embodiment, the reconstruction image feature includes a source image feature, a target image feature and a mixed image feature. The image structure feature includes a source image structure feature and a target image structure feature. The image texture feature includes a source image texture feature and a target image texture feature. As shown in FIG. 4, the specific process of the step 104, reconstructing the image structure feature and the image texture feature to obtain the reconstruction image feature includes steps 402 to 408.

Step 402, splicing the source image structure feature and the source image texture feature to obtain the source image feature.

During implementation, the computer equipment performs splicing processing on the source image structure feature and the source image texture feature to obtain the source image feature.

Step 404, splicing the target image structure feature and the target image texture feature to obtain the target image feature.

During implementation, the computer equipment performs splicing processing on the target structure feature and the target image texture feature to obtain the target image feature.

Step 406, splicing the source image structure feature and the target image texture feature to obtain a first mixed image feature in the mixed image feature.

During implementation, the computer equipment performs splicing processing on the source image structure feature and the target image texture feature to obtain the first mixed image feature in the mixed image feature.

Step 408, splicing the target image structure feature and the source image texture feature to obtain the second mixed image feature in the mixed image feature.

During implementation, the computer equipment performs splicing processing on the target image structure feature and the source image texture feature to obtain the second mixed image feature in the mixed image feature.

In this embodiment, by splicing different image structure features and image texture features, a symmetric image reconstruction architecture is achieved, and the quality of the reconstruction images between data sets and the quality of the reconstruction images in data sets are used to ensure the effectiveness of feature decomposition, thereby effectively verifying the actual effect of the domain-invariant feature extraction.

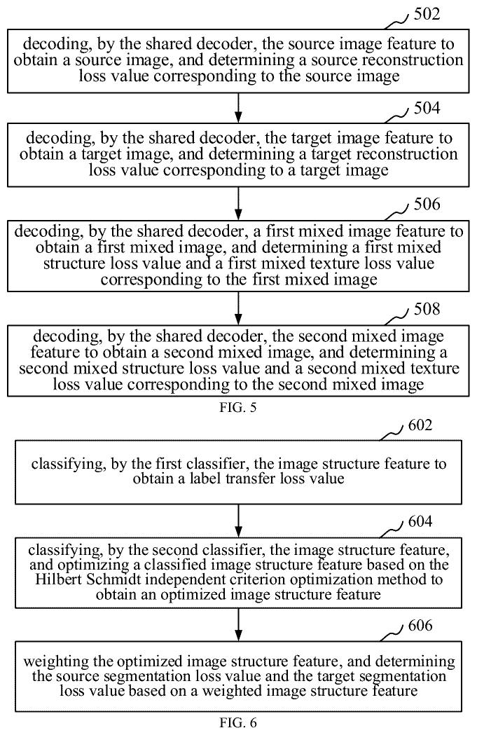

In an embodiment, the reconstruction loss value includes a source reconstruction loss value, a target reconstruction loss value, a first mixed structure loss value, a first mixed texture loss value, a second mixed structure loss value, and a second mixed texture loss value. As shown in FIG. 5, the specific process of the step 104, decoding, by the shared decoder, the reconstruction image feature to obtain the reconstruction loss value set includes steps 502 to 508.

Step 502, decoding, by the shared decoder, the source image feature to obtain a source image, and determining a source reconstruction loss value corresponding to the source image.

During implementation, the computer equipment inputs the source image feature into the shared decoder, and decodes the source image feature through the shared decoder to obtain the source image. The computer equipment then determines the source reconstruction loss value based on the source image.

Step 504, decoding, by the shared decoder, the target image feature to obtain a target image, and determining a target reconstruction loss value corresponding to a target image.

During implementation, the computer equipment inputs the target image feature into the shared decoder, and decodes the target image feature through the shared decoder to obtain the target image. The computer equipment then determines a target reconstruction loss value based on the target image.

In an embodiment, the computer equipment reconstructs the source image structure feature and the source image texture feature that belong to the same data domain to obtain the source reconstruction loss value. In addition, the computer equipment reconstructs the target image structure feature and the target image texture feature that belong to the same data domain to obtain the target reconstruction loss value. The reconstruction task within the data domain in the computer equipment is as shown in the following formula group (1).

$$\begin{matrix}{\tilde{x}}^{s 2 s} = D ( {z}_{s}^{s} , {z}_{p}^{s} ) \\ {\tilde{x}}^{t 2 t} = D ( {z}_{s}^{t} , {z}_{p}^{t} ) \\ {L}_{r e c} ( {θ}_{s} , {θ}_{p}^{s} , {θ}_{p}^{t} , {θ}_{d} ) = {L}_{rec\_str} + {L}_{rec\_tex} \\ = {L}_{rec\_str}^{s} + {L}_{rec\_tex}^{s} + {L}_{rec\_str}^{t} + {L}_{rec\_tex}^{t} \\ = {L}_{V G G} ( {\tilde{x}}^{s 2 s} , {x}^{s} , {w}_{s t r} ) + {L}_{V G G} ( {\tilde{x}}^{s 2 s} , {x}^{s} , {w}_{t e x} ) \\ + {L}_{V G G} ( {\tilde{x}}^{t 2 t} , {x}^{t} , {w}_{str} ) + {L}_{V G G} ( {\tilde{x}}^{t 2 t} , {x}^{t} , {w}_{t e x} )\end{matrix} \qquad ( 1 )$$

In the above formula group (1), \tilde{x}^{s2s} represents the source image. \tilde{x}^{t2t} represents the target image, and D represents the shared decoder. zₛ^{s} represents the source image structure feature, and zₚ^{s} represents the source image texture feature. \tilde{x}^{t2t} represents the target image. zₛ^{t} represents the target image structure feature, and zₚ^{t} represents the target image texture feature. L_{rec} represents the reconstruction loss value. θₛ represents the parameter of the shared encoder. θₚ^{s} represents the parameter of the source domain-specific encoder. θₚ^{t} represents the parameter of the target domain-specific encoder. θ_{d} represents the parameter of the shared decoder. L_{rec_str} represents the reconstruction structure loss value, and L_{rec_tex} represents the reconstruction texture loss value. L_{rec_str}^{s} represents the source reconstruction structure loss value. L_{rec_tex}^{s} represents the source reconstruction texture loss value. L_{rec_str}^{t} represents the target reconstruction structure loss value, and L_{rec_tex}^{t} represents the target reconstruction texture loss value. L_{VGG} represents the loss of the VGG network that constitutes the encoder. x^{s} represents the first image training set, and x^{t} represents the second image training set. wₛₜᵣ represents the structure weighting set for extracting the image structure feature. wₜₑₓ represents the structure texture set for extracting the image texture feature.

Step 506, decoding, by the shared decoder, a first mixed image feature to obtain a first mixed image, and determining a first mixed structure loss value and a first mixed texture loss value corresponding to the first mixed image.

During implementation, the computer equipment inputs the first mixed image feature into the shared decoder, and decodes the first mixed image feature through the shared encoder to obtain the first mixed image. The computer equipment then determines a first mixed structure loss value and a first mixed texture loss value based on the first mixed image.

Step 508, decoding, by the shared decoder, the second mixed image feature to obtain a second mixed image, and determining a second mixed structure loss value and a second mixed texture loss value corresponding to the second mixed image.

During implementation, the computer equipment inputs the second mixed image feature into the shared decoder, and decodes the second mixed image feature through the shared encoder to obtain the second mixed image. The computer equipment then determines a second mixed structure loss value and a second mixed texture loss value based on the second mixed image.

In an embodiment, the computer equipment reconstructs the source image structure feature and the target image texture feature belonging to two data domains. In addition, the computer equipment performs translation and reconstruction on the target image structure feature and the source image texture feature belonging to two data domains. The translation and reconstruction task across data domains in the computer equipment is as shown in the following formula group (2).

$$\begin{matrix}{L}_{trans} ( {θ}_{s} , {θ}_{p}^{s} , {θ}_{p}^{t} , {θ}_{d} ) = {L}_{t r a n {s}_{-} s t r} + {L}_{t r a n {s}_{-} t e x} \\ = {L}_{trans\_str}^{s 2 t} + {L}_{trans\_tex}^{t 2 s} + {L}_{trans\_str}^{s 2 t} + {L}_{trans\_tex}^{t 2 s} \\ = {L}_{V G G} ( {\tilde{x}}^{s 2 t} , {x}^{s} , {w}_{str} ) + {L}_{V G G} ( {\tilde{x}}^{t 2 s} , {x}^{s} , {w}_{t e x} ) \\ + {L}_{V G G} ( {\tilde{x}}^{t 2 s} , {x}^{t} , {w}_{str} ) + {L}_{V G G} ( {\tilde{x}}^{s 2 t} , {x}^{t} , {w}_{t e x} )\end{matrix} \qquad ( 2 )$$

In the above formula group (1), \tilde{x}^{s2s} represents the source image and \tilde{x}^{t2t} represents the target image. x^{s} represents the first image training set, and x^{t} represents the second image training set. L_{rec} represents the translation reconstruction loss value. θₛ represents the parameter of the shared encoder, θₚ^{s} represents the parameter of the source domain-specific encoder, θₚ^{t} represents the parameter of the target domain-specific encoder. θ_{d} represents the parameter of the shared decoder. L_{trans_str} represents the translation reconstruction structure loss value. L_{trans_tex} represents the translation reconstruction texture loss value. L_{trans_str}^{s2t} represents the first mixed structure loss value. L_{trans_tex}^{t2s} represents the first mixed texture loss value. L_{trans_str}^{s2t} represents the second mixed structure loss value. L_{trans_tex}^{t2s} represents the second mixed texture loss value. L_{VGG} represents the loss of the VGG network that constitutes the encoder. wₛₜᵣ represents the structure weighting set for extracting the image structure feature. wₜₑₓ represents the structure texture set for extracting the image texture feature.

In this embodiment, the source image feature, the target image feature and the mixed image feature are decoded, the reconstruction loss value set is determined, which is convenient to subsequently update the decoder. Moreover, the present application proposes a symmetric disentanglement and reconstruction architecture for extracting the domain-invariant feature.

In an embodiment, the classification loss value set includes a label transfer loss value, a source segmentation loss value and a target segmentation loss value. The classifier includes a first classifier and a second classifier. As shown in FIG. 6, the step 106, classifying, by the classifier, the image structure feature to obtain the classification loss value set includes steps 602 to 606.

Step 602, classifying, by the first classifier, the image structure feature to obtain a label transfer loss value.

A gradient of the first classifier is an inversion gradient. The first classifier includes a gradient inversion layer.

During implementation, the computer equipment simultaneously inputs the first image structure feature and the second image structure feature in the image structure feature into the first classifier, classifies the image structure feature through the first classifier, and determines the label transfer loss value. The gradient of the first classifier (the gradient is taken a negative value during gradient back propagation) is inverted, which helps the shared encoder to deceive the first classifier, so that the image structure feature are not classified by the first classifier.

Step 604, classifying, by the second classifier, the image structure feature, and optimizing a classified image structure feature based on the Hilbert Schmidt independent criterion optimization method to obtain an optimized image structure feature.

During implementation, the computer equipment inputs the image structure feature into the second classifier, and classifies the image structure feature through the second classifier to obtain classified image structure feature. Then, the computer equipment optimizes the classified image structure feature according to the Hilbert Schmidt independent criterion optimization method to obtain the optimized image structure feature.

In an embodiment, the Hilbert-Schmidt independence criterion (HSIC) requires that the squared Hilbert-Schmidt norm of ΣAB must be zero, which can be used as a supervised feature decorrelation criterion. In order to eliminate unwanted correlations between any variable in the classified image structure feature representation and Z_{{:,i}}, Z_{{:,j}}, the computer equipment quantifies their relationship through a partial cross-covariance matrix. Z_{{:,j}} is the i-th column feature variable in the source image structure feature after classifying and processing, and Z_{{:,j}} is the j-th column feature variable in the target image structure feature after classifying and processing. The covariance matrix is as shown in the following formula group (3).

$$\begin{matrix}\sum AB = \frac{1}{n - 1} {\sum }_{i = 1}^{n} [ ( u ( {A}_{i} ) - \frac{1}{n} {\sum }_{j = 1}^{n} u ( {A}_{j} ) ) * ( v ( {B}_{i} ) - \frac{1}{n} {\sum }_{k = 1}^{n} v ( {B}_{j} ) ) ] \\ \begin{matrix}u ( A ) = ( {u}_{1} ( A ) , {u}_{2} ( A ) , …… , {u}_{{n}_{A}} ( A ) ) & {u}_{j} ( A ) ∈ {H}_{R F F} , ∀ j\end{matrix} \\ \begin{matrix}v ( B ) = ( {v}_{1} ( B ) , {v}_{2} ( B ) , …… , {v}_{{n}_{B}} ( B ) ) & {v}_{k} ( B ) ∈ {H}_{R F F} , ∀ k\end{matrix}\end{matrix}$$

The formula group (3) represents that u(A) and v(B) are the set of vector functions defined on domains A and B respectively. n_{A} and n_{b} represent the number of functions. In an embodiment, for each function, uⱼ(A) and vₖ(B) represent real-valued eigenvector fourier feature (RFF) in the feature space H_{RFF} that have used randomly mapping. j is an index indicating each basis function.

After determining the covariance matrix, the computer equipment transforms the covariance matrix based on the kernel function to obtain a new kernel matrix. The kernel function can map the original feature vector into a high-dimensional space to better express the similarity of two features. Then, the computer equipment uses the converted kernel matrix to calculate the HSIC between the source image structure feature and the target image structure feature after classifying and processing. HSIC measures the independence of these two features by comparing the correlation of the two features. The computer equipment further optimizes the representation of the classified source image structure feature and the classified target image structure feature based on the parameters of the classified source image structure feature and the classified target image structure feature or by selecting different kernel functions. The optimization goal is to maximize the value of HSIC to achieve the best feature expression.

Step 606, weighting the optimized image structure feature, and determining the source segmentation loss value and the target segmentation loss value based on a weighted image structure feature.

During implementation, the computer equipment performs weighting processing on the optimized image structure feature to obtain weighted image structure feature. Then the computer equipment calculates the source segmentation loss value and the target segmentation loss value based on the weighted image structure feature.

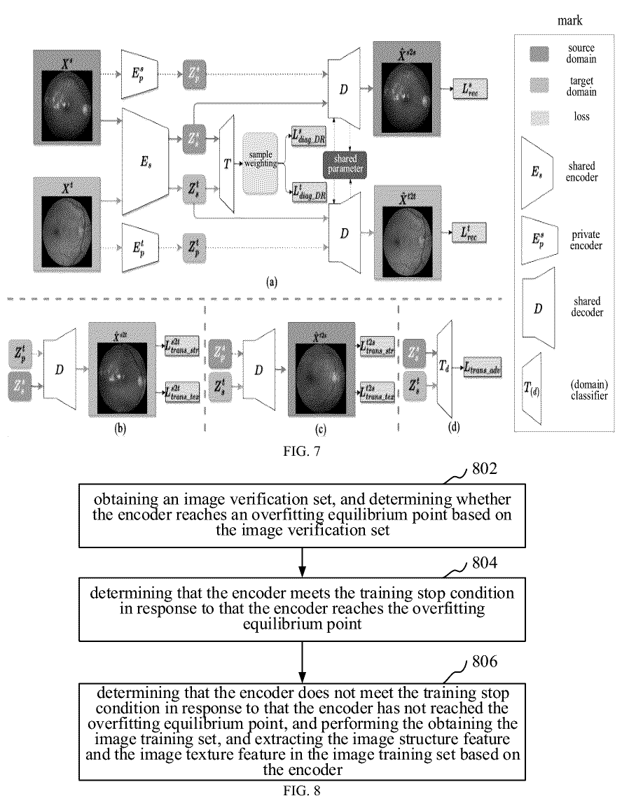

In an embodiment, FIG. 7 is a schematic structure diagram for determining to process the image structure feature. FIG. 7 also shows the secondary screening process of the two-stage structure feature. The computer equipment will perform independence constraints on the components in the latent feature space. In FIG. 7, the computer equipment obtains the image structure feature by encoding the image training set for the shared encoder Eₛ. The computer equipment classifies the image structure feature through a domain classifier (which is also called the first classifier) to obtain the mark transfer loss. The mark source represents the source and the mark target represents the target. When the domain classifier performs the back propagation algorithm, the gradient will be reversed through the gradient reversal layer to help the shared encoder deceive the domain classifier. In an embodiment, a gradient inversion layer inverts the gradient

$$λ \frac{\partial {L}_{t r a n {s}_{-} a d v}}{\partial {θ}_{c}}$$

into the gradient

$$- λ \frac{\partial {L}_{t r a n {s}_{-} a d v}}{\partial {θ}_{s}} .$$

λ represents the hyperparameter. L_{trans_adv} represents the loss function. θₛ is the parameter of the shared encoder, and θ_{c} is the parameter of the domain classifier. ∂ is the derivation symbol. The computer equipment will classify the image structure feature through a classifier, and optimize the classified image structure feature to obtain optimized image structure feature. When performing back propagation, the classifier will inverts the gradient

$$λ \frac{\partial {L}_{t r a n {s}_{-} a d v}}{\partial {θ}_{c}}$$

into the gradient

$$- λ \frac{\partial {L}_{t r a n {s}_{-} a d v}}{\partial {θ}_{s}} .$$

λ is the hyperparameter. L_{trans_adv} is the loss function. θₛ is the parameter of the shared encoder, and θ_{c} is the parameter of the domain classifier. ∂ is the derivation symbol. Then the computer equipment will perform weighting processing (sample weighting) based on the image structure feature optimized according to sample weights (sample weights) to obtain the source segmentation loss value and the target segmentation loss value. The Fourier feature extractor (RFF Extractor) will be used in the optimization process. Random Fourier feature (RFF) is a technology approximate to a kernel function in high-dimensional space, especially when using the kernel method, such as the support vector machine (SVM) and Gaussian process (GP), etc. This technology can map nonlinear kernel methods into linear feature space, thereby reducing computational costs and making it more feasible to run kernel methods on large-scale data sets. RFF Maps are Fourier feature maps. Learning sample weight for decorrelation (LSWD) can be used in the weighting process, which is used for decorrelation in the learning sample weight. The mark Labels represents the label, the mark prediction represents the prediction, the mark prediction loss represents the prediction loss, the mark final loss represents the final loss, and the mark Elementwise multiplication represents the element product.

In this embodiment, by classifying the image structure feature and optimizing the classified image structure feature, confounding factors in the image structure feature are eliminated, the image structure feature are further positioned, and the local positioning in domain invariant feature structure is refined, to further improve the robustness of the feature extraction model.

In an embodiment, after updating the parameters of the encoder, it is necessary to determine whether the updated encoder meets the training stop condition. As shown in FIG. 8, before step 108 is executed, the specific processing process of the image data processing method includes steps 802 to 806.

Step 802, obtaining an image verification set, and determining whether the encoder reaches an overfitting equilibrium point based on the image verification set.

During implementation, the computer equipment obtains an image verification set. The computer equipment determines the accuracy curve and the loss curve of the encoder based on the image validation set. Then, the computer equipment determines whether the encoder has reached the overfitting equilibrium point based on the accuracy curve and the loss value curve.

Step 804, determining that the encoder meets the training stop condition in response to that the encoder reaches the overfitting equilibrium point.

During implementation, when the encoder reaches an overfitting equilibrium point, the computer equipment determines that the encoder reaches a preset training stop condition. The computer equipment then determines the shared encoder in the encoders as the feature extraction model.

Step 806, determining that the encoder does not meet the training stop condition in response to that the encoder has not reached the overfitting equilibrium point, and performing the obtaining the image training set, and extracting the image structure feature and the image texture feature in the image training set based on the encoder.

During implementation, when the encoder does not reach the overfitting equilibrium point, the computer equipment determines that the encoder has not reached the training stop condition, and the computer equipment continues to train the encoder until the encoder reaches the training stop condition. In an embodiment, the computer equipment continues to obtain the image training set and extract the image structure feature and image texture feature from the image training set based on the encoder until the encoder reaches the training stop condition.

In this embodiment, the image verification set is used to determine the situation when the encoder reaches the overfitting equilibrium point, which can clarify the current feature extraction effect of the encoder, and when the encoder reaches the training stop condition, the shared encoder is determined as the feature extraction model, and a target shared encoder that can accurately extract image structure feature is obtained. By extracting common image structure feature in the image, the accuracy of the feature extraction model is improved, thereby improving the accuracy of identifying diseased types.

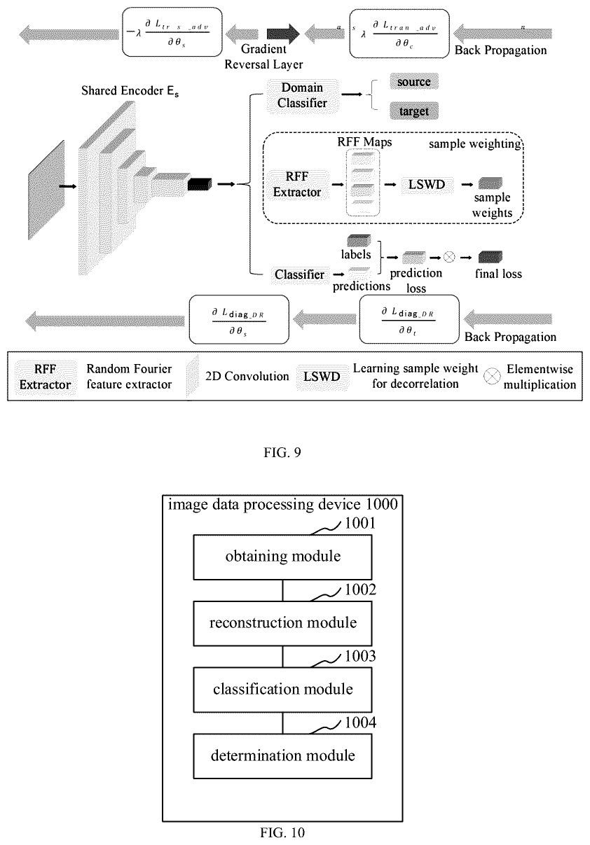

In an embodiment, FIG. 9 is a schematic flowchart of determining the reconstruction loss value set and the classification loss value set, which is also a one-stage symmetric decoupling framework diagram. The computer equipment decomposes the original image into the structure feature with domain invariance and the texture feature with domain invariance. As shown in FIG. 9, the computer equipment obtains the image training set. x^{s} is the first image training set and x^{t} is the second image training set. The computer equipment separately encodes the first image training set and the second image training set based on the shared encoder Eₛ to obtain the source image structure feature zₛ^{s} corresponding to the first image training set and the target image structure feature zₛ^{t} corresponding to the second image training set. The computer equipment performs encoding processing on the first image training set based on the source domain-specific encoder Eₚ^{s} to obtain source image texture feature zₚ^{s}. The computer equipment encodes the second image training set based on the target domain-specific encoder Eₚ^{t} to obtain the target image texture feature zₚ^{t}. The computer equipment splices the source image structure feature and the source image texture feature to obtain the source image feature, and decodes the source image feature through the shared decoder to obtain the source image \hat{x}^{s2s}. The computer equipment determines a source reconstruction loss value L_{rec}^{s} corresponding to the source image. The computer equipment splices the target image structure feature and the target image texture feature to obtain the target image feature, and decodes the target image feature through the shared decoder to obtain the target image \hat{x}^{t2t}. The computer equipment determines a target reconstruction loss value L_{rec}^{t} corresponding to the target image. The computer equipment performs splicing processing on the source image structure feature and the target image texture feature to obtain the first mixed image feature, and decodes the first mixed image feature through the shared decoder to obtain the first mixed image \hat{x}^{s2t}. The computer equipment determines a first mixed structure loss value L_{trans_str}^{s2t} and a first mixed texture loss value L_{trans_tex}^{t2s} corresponding to the first mixed image. The computer equipment performs splicing processing on the target image structure feature and the source image texture feature to obtain the second mixed image feature, and decodes the second mixed image feature through the shared decoder to obtain the second mixed image \hat{x}^{t2s}. The computer equipment determines a second mixed structure loss value L_{trans_str}^{s2t} and a second mixed texture loss value L_{trans_tex}^{t2s} corresponding to the second mixed image. The computer equipment classifies the image structure feature through the first classifier T_{d} to obtain a label transfer loss value L_{trans_adv}. The computer equipment classifies the image structure feature through the second classifier T, and optimizes the classified image structure feature to obtain optimized image structure feature. Then, the computer equipment performs weighting processing (Sample Weighting) on the optimized image structure feature, and determines the source segmentation loss value L_{diag_DR}^{s} and the target segmentation loss value L_{diag_DR}^{t} based on the weighted image structure feature.

It should be understood that although the steps in the flowcharts in the above embodiments are shown in sequence as indicated by the arrows, these steps are not necessarily executed in the order indicated by the arrows. Unless explicitly stated in the present application, there is no strict order restriction on the execution of these steps, and these steps can be executed in other orders. Moreover, at least some steps in the flowcharts of the above embodiments may include multiple steps or multiple stages. These steps or stages are not necessarily executed at the same time, but may be executed at different times. The execution order of these steps or stages is not necessarily sequential, but may be performed in turn or alternately with other steps or at least part of the steps or stages in other steps.

Based on the same inventive concept, embodiments of the present application also provide an image data processing device for implementing the above-mentioned image data processing method. The solution to the problem provided by this device is similar to the solution described in the above method. Therefore, the following specific limitations of embodiments in one or more image data processing device can refer to the above description of the image data processing method, which will not be repeated here.

In an embodiment, as shown in FIG. 10, an image data processing device 1000 is provided, which includes an obtaining module 1001, a reconstruction module 1002, a classification module 1003 and a determination module 1004.

The obtaining module 1001 is configured to obtain an image training set, and extract image structure feature and image texture feature from the image training set based on the encoder.

The reconstruction module 1002 is configured to reconstruct image structure feature and image texture feature to obtain reconstruction image feature, and decode the reconstruction image feature through a shared decoder to obtain a reconstruction loss value set.

The classification module 1003 is configured to classify the image structure feature through a classifier, obtain a classification loss value set, and update the parameters of the encoder and the shared decoder based on the reconstruction loss value set and the classification loss value set.

The determination module 1004 is configured to determine the shared encoder in the encoder as a feature extraction model when the updated encoder meets the training stop condition. The feature extraction model is configured to extract image structure feature in the image.

In an embodiment, the encoder includes a shared encoder and a domain-specific encoder, and the obtaining module 1001 includes a first obtaining sub-module and a first extraction sub-module. The first obtaining sub-module includes:
a first processing sub-module configured to encoding the first image training set in the image training set to obtain the source image structure feature in the image structure feature;
a second processing sub-module configured to encode the second image training set in the image training set based on the shared encoder to obtain the target image structure feature in the image structure feature;
a third processing sub-module configured to encode the image training set according to the domain-specific encoder to obtain the image texture feature.

In an embodiment, the third processing sub-module includes:
a first encoding sub-module configured to encode the first image training set according to the source domain-specific encoder to obtain the source image texture feature;
a second encoding sub-module configured to encode the second image training set according to the target domain-specific encoder to obtain the target image texture feature.

In an embodiment, the domain-specific encoder includes a source domain-specific encoder and a target domain-specific encoder, the image texture feature includes a source image texture feature and a target image texture feature, and the reconstruction module 1002 includes a first construction sub-module and the first decoding sub-module. The first reconstruction sub-module includes:
a first splicing sub-module configured to splice the source image structure feature and the source image texture feature to obtain the source image feature;
a second splicing sub-module configured to splice the target image structure feature and the target image texture feature to obtain the target image feature;
a third splicing sub-module configured to splice the source image structure feature and the target image texture feature to obtain the first mixed image feature in the mixed image feature;
a fourth splicing sub-module configured to splice the target image structure feature and the source image texture feature to obtain the second mixed image feature in the mixed image feature.

In an embodiment, the reconstruction loss value includes a source reconstruction loss value, a target reconstruction loss value, a first mixed structure loss value, a first mixed texture loss value, a second mixed structure loss value, and a second mixed texture loss value. The reconstruction module 1002 includes a first reconstruction sub-module and a first decoding sub-module. The first decoding sub-module includes:
a second decoding sub-module configured to decode the source image feature through the shared decoder to obtain the source image, and determine the source reconstruction loss value corresponding to the source image;
a third decoding sub-module configured to decode the target image feature through the shared decoder, obtain the target image, and determine the target reconstruction loss value corresponding to the target image;
a fourth decoding sub-module configured to decode the first mixed image feature through the shared decoder to obtain the first mixed image, and determine the first mixed structure loss value and the first mixed texture loss value corresponding to the first mixed image;
a fifth decoding sub-module configured to decode the second mixed image feature through the shared decoder to obtain the second mixed image, and determine the second mixed structure loss value and the second mixed texture loss value corresponding to the second mixed image.

In an embodiment, the classification loss value set includes a label transfer loss value, a source segmentation loss value and a target segmentation loss value. The classifier includes a first classifier and a second classifier. The classification module 1003 includes a first classification sub-module and the first update sub-module. The first category sub-module includes:
a second classification sub-module configured to classify the image structure feature according to the first classifier and obtain the label transfer loss value. The gradient of the first classifier is the inversion gradient;
a third classification sub-module configured to classify the image structure feature according to the second classifier, and optimize the classified image structure feature based on the Hilbert Schmidt independent criterion optimization method to obtain optimized image structure feature; and
a weighting processing module configured to perform weighting processing on the optimized image structure feature, and determine the source segmentation loss value and the target segmentation loss value based on the weighted image structure feature.

In an embodiment, the image data processing device 1000 includes:
a second obtaining module configured to obtain the image verification set and determine whether the encoder has reached the overfitting equilibrium point based on the image verification set;
a second determination module configured to determine that the encoder reaches the preset training stop condition when the encoder reaches the overfitting equilibrium point;
a third determination module configured to determine that the encoder has not reached the training stop condition when the encoder has not reached the overfitting equilibrium point, and executes the obtaining of the image training set, and performing steps for extracts the image structure features and image texture features in the image training set based on the encoder.

Each module in the above-mentioned image data processing device can be implemented in whole or in part by software, hardware, and combinations thereof. Each of the above modules can be embedded in or independent of the processor in the computer equipment in the form of hardware, or can be stored in the memory of the computer equipment in the form of software, so that the processor can call and execute the operations corresponding to each of the above modules.

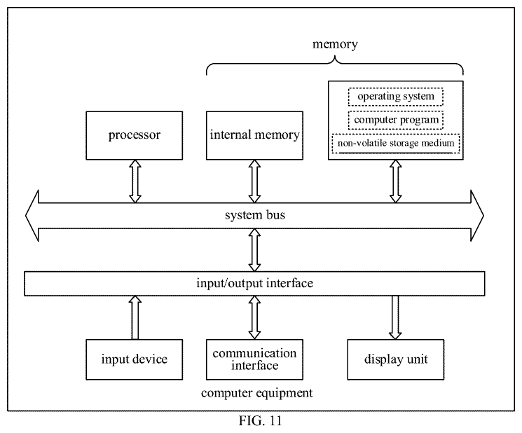

In an embodiment, a computer equipment is provided. The computer equipment may be a terminal, and the internal structure diagram may be as shown in FIG. 11. The computer equipment includes a processor, a memory, an input/output interface, a communication interface, a display unit and an input device. The processor, the memory, and the input/output interface are connected through the system bus, and the communication interface, the display unit and the input device are connected to the system bus through the input/output interface. The processor of the computer equipment is configured to provide computing and control capabilities. The memory of the computer equipment includes the non-volatile storage media and the internal memory. The non-volatile storage medium stores operating systems and computer programs. This internal memory provides an environment for the execution of operating systems and computer programs in non-volatile storage media. The input/output interface of the computer equipment is configured to exchange information between the processor and external equipments. The communication interface of the computer equipment is used for wired or wireless communication with external terminals. The wireless mode can be implemented through WIFI, mobile cellular network, near field communication (NFC) or other technologies. When the computer program is executed by a processor, an image data processing method is implemented. The display unit of the computer equipment is configured to form a visually visible picture, which may be a display screen, a projection device or a virtual reality imaging device. The display screen can be a liquid crystal display or an electronic ink display. The input device of the computer equipment can be a touch layer covered on the display screen, or can be a button, a trackball or a touch pad provided on the computer equipment casing, or can be the keyboard, the touch pad or the mouse, etc.

Those skilled in the art can understand that the structure shown in FIG. 11 is only a block diagram of a partial structure related to the solution of the present application, and does not constitute a limitation on the computer equipment to which the solutions of the present application are applied. The computer equipment can include more or fewer parts than shown, or combine certain parts, or have a different arrangement of parts.

In an embodiment, a computer equipment is also provided, which includes a memory and a processor. A computer program is stored in the memory. When the processor executes the computer program, the steps in the above method embodiments are implemented.

In an embodiment, a computer-readable storage medium is provided, a computer program is stored thereon, and when the computer program is executed by a processor, the steps in the above method embodiments are implemented.

In an embodiment, a computer program product is provided, which includes a computer program that implements the steps in each of the above embodiments when the computer program is executed by a processor.

Those skilled in the art can understand that all or part of the processes in the methods of the above embodiments can be completed by instructing relevant hardware through a computer program. The computer program can be stored in a non-volatile computer-readable storage. When the computer program is executed, it may include the processes of the embodiments of the above methods. Any reference to the memory, the database or other media used in the embodiments of the present application may include at least one of the non-volatile memory and the volatile memory. The non-volatile memory can include the read-only memory (ROM), the magnetic tape, the floppy disk, the flash memory, the optical memory, the high-density embedded non-volatile memory, the resistive memory (ReRAM), the magneto resistive random access memory (MRAM), the ferroelectric random access memory (FRAM), the phase change memory (PCM), and the graphene memory, etc. The volatile memory may include the random access memory (RAM) or the external cache memory. As an illustration and not a limitation, RAM can be in various forms, such as the static random access memory (SRAM) or the dynamic random access memory (DRAM). The databases in the various embodiments of the present application may include at least one of a relational database and a non-relational database. Non-relational databases may include block chain-based distributed databases, etc., but are not limited thereto. The processors involved in the various embodiments of the present application may be general-purpose processors, central processors, graphics processors, digital signal processors, programmable logic devices, quantum computing-based data processing logic devices, etc., which are not limited to here.

The technical features of the above embodiments can be combined in any way. To simplify the description, not all possible combinations of the technical features in the above embodiments are described. However, as long as there is no contradiction in the combination of these technical features, all possible combinations should be used, and this should be considered to be within the scope of the present application.

The above embodiments only several implementation modes of the present application, and their descriptions are relatively specific and detailed, but should not be construed as limiting the scope of the present application. It should be noted that, for those skilled in the art, several modifications and improvements can be made without departing from the concept of the present application, and these all fall within the scope of the present application. Therefore, the scope of the present application should be determined by the appended claims.

What is claimed is:

1. An image data processing method, comprising:
obtaining an image training set, and extracting an image structure feature and an image texture feature in the image training set based on an encoder;
reconstructing the image structure feature and the image texture feature to obtain a reconstruction image feature, and decoding, by a shared decoder, the reconstruction image feature to obtain a reconstruction loss value set;
classifying, by a classifier, the image structure feature to obtain a classification loss value set, and updating parameters of the encoder and the shared decoder based on the reconstruction loss value set and the classification loss value set; and
determining the shared encoder in the encoder as a feature extraction model in response to that an updated encoder meets a training stop condition, wherein the feature extraction model is configured to extract an image structure feature in an image.

2. The method of claim 1, wherein:
the encoder comprises the shared encoder and a domain-specific encoder;
the extracting the image structure feature and the image texture feature in the image training set based on the encoder comprises:
encoding a first image training set in the image training set based on the shared encoder to obtain a source image structure feature in the image structure feature;
encoding a second image training set in the image training set based on the shared encoder to obtain a target image structure feature in the image structure feature; and
encoding the image training set according to the domain-specific encoder to obtain the image texture feature.

3. The method of claim 2, wherein:
the domain-specific encoder comprises a source domain-specific encoder and a target domain-specific encoder, and the image texture feature comprises a source image texture feature and a target image texture feature;
the encoding the image training set according to the domain-specific encoder to obtain the image texture feature comprises:
encoding the first image training set according to the source domain-specific encoder to obtain the source image texture feature; and
encoding the second image training set according to the target domain-specific encoder to obtain the target image texture feature.

4. The method of claim 1, wherein:
the reconstruction image feature comprises a source image feature, a target image feature and a mixed image feature, the image structure feature comprises a source image structure feature and a target image structure feature, and the image texture feature comprises a source image texture feature and a target image texture feature;
the reconstructing the image structure feature and the image texture feature to obtain the reconstruction image feature comprises:
splicing the source image structure feature and the source image texture feature to obtain the source image feature;
splicing the target image structure feature and the target image texture feature to obtain the target image feature;
splicing the source image structure feature and the target image texture feature to obtain a first mixed image feature in the mixed image feature; and
splicing the target image structure feature and the source image texture feature to obtain the second mixed image feature in the mixed image feature.

5. The method of claim 4, wherein:
the reconstruction loss value comprises a source reconstruction loss value, a target reconstruction loss value, a first mixed structure loss value, a first mixed texture loss value, a second mixed structure loss value, and a second mixed texture loss value;
the decoding, by the shared decoder, the reconstruction image feature to obtain the reconstruction loss value set comprises:
decoding, by the shared decoder, the source image feature to obtain a source image, and determining a source reconstruction loss value corresponding to the source image;
decoding, by the shared decoder, the target image feature to obtain a target image, and determining a target reconstruction loss value corresponding to a target image;
decoding, by the shared decoder, a first mixed image feature to obtain a first mixed image, and determining a first mixed structure loss value and a first mixed texture loss value corresponding to the first mixed image; and
decoding, by the shared decoder, the second mixed image feature to obtain a second mixed image, and determining a second mixed structure loss value and a second mixed texture loss value corresponding to the second mixed image.

6. The method of claim 1, wherein:
the classification loss value set comprises a label transfer loss value, a source segmentation loss value and a target segmentation loss value, and the classifier comprises a first classifier and a second classification;
the classifying, by the classifier, the image structure feature to obtain the classification loss value set comprises:
classifying, by the first classifier, the image structure feature to obtain the label transfer loss value, wherein a gradient of the first classifier is an inversion gradient;
classifying, by the second classifier, the image structure feature, and optimizing a classified image structure feature based on the Hilbert Schmidt independent criterion optimization method to obtain an optimized image structure feature; and
weighting the optimized image structure feature, and determining the source segmentation loss value and the target segmentation loss value based on a weighted image structure feature.

7. The method of claim 1, wherein before the determining the shared encoder in the encoder as the feature extraction model in response to that the updated encoder meets the training stop condition, the method further comprises:
obtaining an image verification set, and determining whether the encoder reaches an overfitting equilibrium point based on the image verification set;
determining that the encoder meets a preset training stop condition in response to that the encoder reaches the overfitting equilibrium point; and
determining that the encoder does not meet the training stop condition in response to that the encoder does not reach the overfitting equilibrium point, and performing the obtaining the image training set, and extracting the image structure feature and the image texture feature in the image training set based on the encoder.

8. An image data processing device, comprising:
an obtaining module, configured to obtain an image training set, and extract an image structure feature and an image texture feature in the image training set based on the encoder;
a reconstruction module, configured to reconstruct the image structure feature and the image texture feature to obtain a reconstruction image feature, and decode the reconstruction image feature through a shared decoder to obtain a reconstruction loss value set;
a classification module, configured to classify the image structure feature through a classifier to obtain a classification loss value set, and update parameters of the encoder and the shared decoder based on the reconstruction loss value set and the classification loss value set; and
a determination module, configured to determine the shared encoder in the encoder as a feature extraction model in response to that an updated encoder meets a training stop condition, wherein the feature extraction model is configured to extract an image structure feature in an image.

9. A computer equipment, comprising a memory and a processor, wherein the memory stores a computer program, and when the computer program is executed by the processor, the method of claim 1 is implemented.

10. Anon-transitory computer-readable storage medium, storing a computer program thereon, wherein when the computer program is executed by a processor, the method of claim 1 is implemented.
